(19) United States
(12) Patent Application Publication
(10) Pub. No.: US 2020/0321650 A1
(43) Pub. Date: Oct. 8, 2020

(54) BATTERY CELL DESIGN WITH A NON-INVASIVE LITHIUM REFERENCE LEAD

(71) Applicants: Chongqing Jinkang New Energy Automobile Co., Ltd., Chongqing (CN); SF Motors Inc., Santa Clara, CA (US)

(72) Inventors: Scott Monismith, Santa Clara, CA (US); Brennan Campbell, Santa Clara, CA (US); Derek Wong, Santa Clara, CA (US); Ying Liu, Santa Clara, CA (US); Yifan Tang, Santa Clara, CA (US)

(21) Appl. No.: 16/373,610

(22) Filed: Apr. 2, 2019

(51) Int. Cl. H01M 10/0525; H01M 4/88; B60L 50/60; H01M 2/02

(52) U.S. Cl. CPC H01M 10/0525; H01M 2/0277; B60L 50/60; H01M 4/8896

(57) ABSTRACT

A battery cell providing a non-invasive reference lead includes a cap positioned at a top of the battery cell, where the cap includes an anode section and a cathode section separated by an insulator section. The battery cell also includes a jelly roll comprising an anode lead and a cathode lead extending from a top of the jelly roll. The anode lead of the jelly roll is electrically coupled to the anode section of the cap, and the cathode lead of the jelly roll is electrically coupled to the cathode section of the cap. The battery cell further includes a lithium sleeve providing a reference lead for the battery cell. The lithium sleeve and the cap enclose the jelly roll.

### BACKGROUND

Lithium-ion (“Li-ion”) batteries are extensively used for energy storage applications. These applications include powering electric vehicles (“EVs”) and personal electric devices, such as laptops computers, digital music players, smart phones, and so forth. Li-ion batteries are particularly advantageous in these application due to their high energy density, high operational voltage, and low self-discharge rate. However, despite their widespread use and growing popularity, serious technical challenges remain in the use of Li-ion cells. These challenges include range per charge, charging time, cost, safety, and most importantly, cell lifetime. These challenges are especially pronounced in EV applications where long-term cycling and lifetimes of 10-15 years are expected.

Battery cells are an intensely complicated mesh of side reactions, non-equilibrium kinetics, and fluctuations in electrical potential that are difficult to characterize from outside observation of the anode and cathode alone. Typically, in order to investigate the detailed non-equilibrium kinetics and thermodynamics of electrochemical cells, special construction of a three-electrode cell is required. A three-electrode cell is a cell in which a “reference electrode” is placed in the battery cell. However, the reference electrode must also stay electrically isolated from the actual working of the electrodes. This allows the reference electrode to act as a stable, known electrochemical potential with which to compare measured potentials at the anode and cathode terminals. This allows for the ready calculation of individual electrode potentials instead of simply measuring the book electrochemical potential difference between the electrodes. This also allows for measurement of kinetic variables and/or constants, such as the over-potential, while tracking the prevalence and impact of additional side reactions within the cell.

### BRIEF SUMMARY

In some embodiments, a battery cell providing a non-invasive reference lead may include a cap positioned at a top of the battery cell. The cap may include an anode section and a cathode section separated by an insulator section. The battery cell may also include a jelly roll comprising an anode lead and a cathode lead extending from a top of the jelly roll. The anode lead of the jelly roll may be electrically coupled to the anode section of the cap; and the cathode lead of the jelly roll may be electrically coupled to the cathode section of the cap. The battery cell may further include a lithium sleeve providing a reference lead for the battery cell. The lithium sleeve and the cap may enclose the jelly roll.

In any embodiments, any of the following features may be included in any combination and without limitation. The battery cell may also include an aluminum can between the jelly roll and the lithium sleeve. The aluminum can may be spot welded to the lithium sleeve. The jellyroll may form a lithium-ion battery cell. The lithium sleeve may include a cylindrical shape with a closed bottom and an open top. The battery cell may be one of a plurality of battery cells providing power to an electric vehicle. The cap may include a first aluminum section surrounded by an insulator. The cap may include a second aluminum section that is crimped around the insulator. An electrical measurement between the anode and the cathode can be obtained from the cap without accessing the lithium sleeve. The battery cell may be part of a laboratory test environment.

In some embodiments, a method of providing a battery cell with a non-invasive reference lead may include inserting a jelly roll into a lithium sleeve. The jelly roll mayinclude an anode lead and a cathode lead extending from a top of the jelly roll; and the lithium sleeve may provide a reference lead for the battery cell. The method may also include filling the battery cell with electrolyte and coupling a cap to the lithium sleeve to enclose the jelly roll. The cap may include an anode section and a cathode section separated by an insulator section. The method may additionally include electrically coupling the anode lead of the jelly roll to the anode section of the cap; and electrically coupling the cathode lead of the jelly roll to the cathode section of the cap.

In any embodiments, any of the following features may be included in any combination and without limitation. The method may also include obtaining an electrical measurement between the anode section and the cathode section of the cap. The method may additionally include obtaining an electrical measurement between the anode section of the cap and the reference lead. The method may further include obtaining an electrical measurement between the cathode section of the cap and the reference lead. The method may also include providing an electrical measurement using the reference lead to a Battery Management System (BMS) of an electric vehicle. The method may additionally include inserting the jellyroll into an aluminum can, and inserting the aluminum can into the lithium sleeve. The method may also include spot welding a bottom of the aluminum can to a bottom of the lithium sleeve. The jellyroll may include layers of a lithium-ion battery cell. The method may further include providing power from the battery cell to electric motor of an electric vehicle. The cap may include a first aluminum section surrounded by an insulator.

### BRIEF DESCRIPTION OF THE DRAWINGS

A further understanding of the nature and advantages of the present invention may be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1A illustrates a simplified diagram of a drivetrain of an electric vehicle, according to some embodiments.

FIG. 1B illustrates a simplified block diagram of a Battery Management System (BMS) 130 that may be used in an electric vehicle, according to some embodiments.

FIG. 2 illustrates a simplified diagram of the layers of a lithium battery used in electric vehicles, according to some embodiments.

FIG. 3 illustrates a simplified diagram of how the various chemistry layers may be rolled up inside of a battery in a jelly roll configuration, according to some embodiments.

FIG. 4 illustrates a diagram of a traditional battery cell.

FIG. 5 illustrates a diagram of an embodiment of a battery cell comprising a non-invasive, integrated third electrode, according to some embodiments.

FIGS. 6A-6B illustrate the use of the double-electrode cap, according to some embodiments.

FIG. 7 illustrates a diagram of how the jelly roll can be electrically coupled to the cap 502, according to some embodiments.

FIG. 8 illustrates an assembled three-electrode battery cell, according to some embodiments.

FIG. 9 illustrates a flowchart of a method for assembling a battery cell that provides a non-invasive reference lead, according to some embodiments.

FIG. 10 illustrates an exemplary computer system, in which various embodiments may be implemented.

### DETAILED DESCRIPTION

Described herein, are embodiments for a non-invasive, three-electrode battery cell that provides a lithium reference lead. A jelly roll can be manufactured where the electrical lead tabs for both the anode and the cathode layers extend from the top side of the jelly roll instead of from alternating sides (i.e., top and bottom sides). A cap has been designed that includes two separate metal regions that form the anode and the cathode for the electric cell. These metal regions on the cap can be electrically coupled to the two metal regions of the cap such that the anode and cathode are both measurable from a top side of the battery cell. The jelly roll can be inserted into a lithium sleeve which may also be spot welded to the aluminum can of the battery cell. The lithium sleeve can then provide a third lithium reference that does not interfere with the internal chemistry of the cell. This lithium reference also can be used in-situ during both testing and real-world applications to provide measurements of the internal kinetics of the battery cell that would otherwise be unavailable from the anode/cathode alone.

Lithium ion battery cells are seeing widespread use in commercial, residential, and automotive applications. However, one of the barriers that prevents lithium-ion batteries from replacing traditional energy technologies is battery charging. For example, the automotive industry is still primarily powered by the traditional gasoline combustion engine. One of the distinct advantages of the combustion engine is how rapidly it can be refueled. For example, a stop at a gas station typically takes less than 5 minutes and can produce hundreds of miles of energy for a vehicle powered by a combustion engine. In contrast, electric vehicles powered by lithium-ion batteries can require more than 30 minutes to recharge the car's battery cells. It is this difference in the rate of refueling versus the rate of recharging that deters many individuals who would otherwise be likely to use an electric vehicle.

In order to make electric vehicles more palatable to the general public, battery charging cycles for electric vehicles should be made as short as possible. Therefore, the ability to rapidly charge lithium-ion batteries is of great importance to the industry. If the batteries in an electric vehicle can be recharged to an 80% state of charge (SOC) in under 30 minutes, electric vehicles may be much more competitive with traditional combustion engines. Therefore, the ability to rapidly charge lithium-ion batteries can provide technological improvements that affect energy efficiency, energy independence, environmental concerns, cost-effectiveness, and provide many other economic and societal benefits.

Additionally, the ability to characterize battery cells during charging and discharging cycles may be very useful for optimizing the charging time and/or lifecycle of the batteries. The first steps in designing lithium-ion cells that have storage capacity and charging times that can compete with combustion-engine vehicles are characterizing an understanding the molecular-level reactions that take place during use. Being able to measure electrical characteristics of the lithium battery cells beyond the bulk measurement between the anode and cathode may be essential for preventing battery degradation modes, lithium plating, lifecycle reductions, and other electrical phenomena that limit the capacity and charge time of electric vehicles.

Battery cells are comprised of an intensely complicated mesh of side reactions, non-equilibrium kinetics, and fluctuations in electrical potential that are difficult to characterize from outside observation of the anode and cathode alone. Typically, in order to investigate the detailed non-equilibrium kinetics and thermodynamics of electrochemical cells, special construction of a three-electrode cell is required. A three-electrode cell is a cell in which a “reference electrode” is placed in the battery cell. However, the reference electrode must also stay electrically isolated from the actual working electrodes. This allows the reference electrode to act as a stable, known electrochemical potential with which to compare measured potentials at the anode and cathode terminals. This also allows for the ready calculation of individual electrode potentials instead of simply measuring the bulk electrochemical potential difference between the electrodes. This additionally allows for the measurement of kinetic variables and/or constants such as an over-potential while tracking the prevalence and impact of additional side reactions within the cell.

However, prior to this disclosure, constructing a three-electrode cell was a very error-prone and time/labor-intensive process. The known techniques for constructing three-electrode cells were rudimentary at best and required precise techniques to avoid interfering with the normal operation of the battery. Precise alignment of the electrodes with one another was essential, otherwise the probability of anomalous results greatly increased. Furthermore, it is important to note that the dissection process previously used to create three-electrode cells was inherently invasive, and it was impossible to successfully remove the third electrode without influencing the final measurements of the cell. Typical three-electrode cells were not inherently useful for other forms of more conventional cycling analysis and characterization, nor could they be used for real-world applications.

To address these and other technology problems in the art, the embodiments described herein provide for a battery cell with a non-invasive reference lead that is easily manufactured and can be used for both characterization/analysis and real-world applications without negatively affecting the performance of the battery cell. Although the examples described below focus specifically on lithium-ion cells used in electric vehicles, one having ordinary skill in the art will readily recognize that not all embodiments are so limited. The techniques described below can be used on other types of battery cells, such as alkaline batteries, NiMH batteries, NiCd batteries, Li-ion batteries, and so forth. Additionally, these embodiments do not require that the three-electrode cell be used in an electric vehicle. Many other real-world applications may benefit from these embodiments, such as consumer electronics, cell phones, GPS devices, portable computing devices, portable communication devices, and so forth.

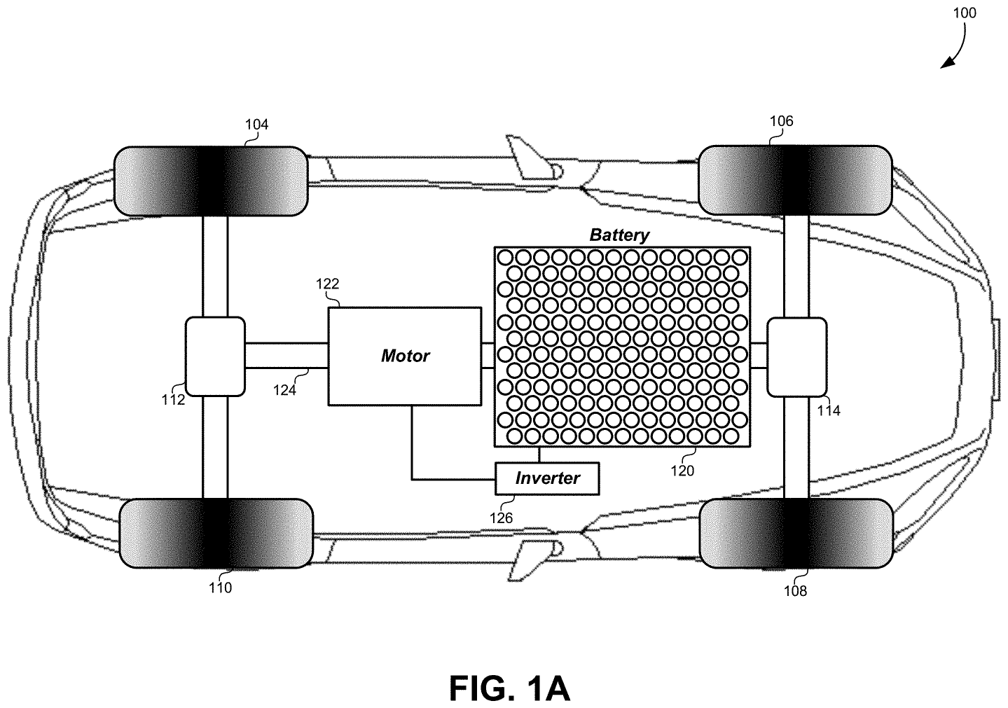

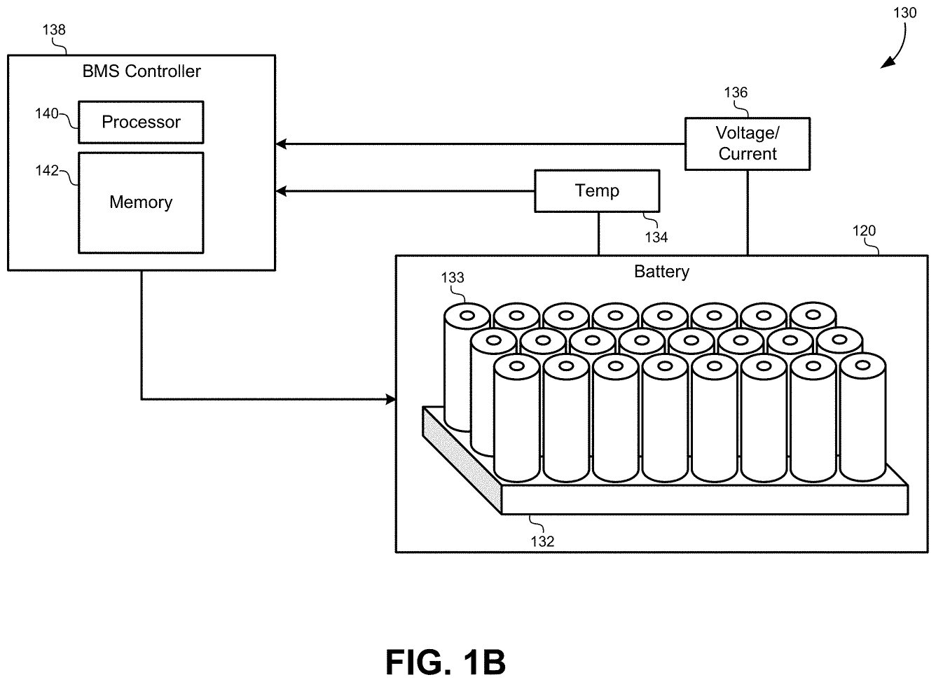

FIG. 1A illustrates a simplified diagram of a drivetrain of an electric vehicle 100, according to some embodiments. The operating conditions and requirements for use in an electric vehicle may be particularly well-suited for the three-electrode cells described herein. The electric vehicle 100 includes a battery 120. The battery 120 may typically be comprised of a plurality of individual battery cells. For example, the battery 120 may include hundreds of lithium-ion battery cells connected in parallel/serial configurations to provide a steady DC voltage and a large amount of current to power the electric vehicle 100. The battery 120 may also be equipped with a temperature management system (TMS) that regulates the temperature of the plurality of individual battery cells. For example, the TMS may include channels for circulating coolant and/or a “cold plate” adjacent to the plurality of individual battery cells. These elements can provide heat to the battery 120 in cold environments and/or remove heat from the battery 120 in warmer operating environments. The TMS can regulate the battery temperature 120 to ensure that the individual battery cells are charged and discharged within an ideal operating temperature range to avoid damage to the individual battery cells (e.g., lithium plating).

The battery 120 may provide DC current to an inverter 126. The inverter 126 can convert the DC current into an AC current that can be circulated through a stator of the motor 122. One or more rotors positioned inside of the stator in the motor 122 can be equipped with permanent magnets. For example, an interior permanent-magnet (IPM) motor or a surface permanent-magnet (SPM) motor may include permanent magnets that are mounted inside or outside of the bodies of the rotors. The windings in the stator through which the AC current flows generates a rotating magnetic field. The rotating magnetic field induces a current in the magnets of the rotors. It is the interaction between the field produced by the stator and the resulting current in the magnets that produces the driving force for the motor 122.

As the rotors of the motor 122 are rotated by virtue of the electric power provided by the battery 120, the rotors turn a shaft 124. Differential modules 112, 114 translate the rotational motion of the shaft 124 into orthogonal rotational motion for the wheels 104, 106, 108, 110 of the electric vehicle 100. In this simplified diagram, only a single motor 122 is used to drive each of the wheels 104, 106, 108, 110. However, other embodiments may use a plurality of motors, each of which drive a subset of the wheels 104, 106, 108, 110. For example, some embodiments may use a first motor to drive the rear wheels 104, 110 along with a second motor to drive the front wheels 106, 108. In these embodiments, a single battery 120 can power each of the plurality of motors, or multiple batteries may provide power to the plurality of motors.

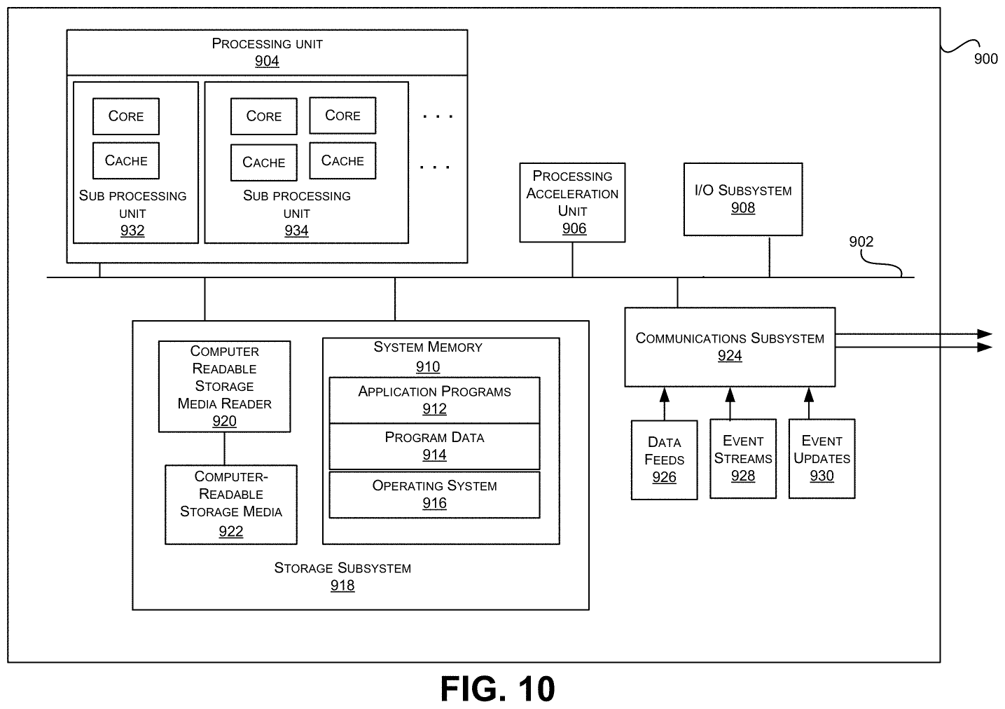

FIG. 1B illustrates a simplified block diagram of a Battery Management System (BMS) 130 that may be used in an electric vehicle, according to some embodiments. As described above, the battery 120 may include a plurality of individual battery cells 133. The BMS 130 may include many electrical and mechanical components, only a portion of which are explicitly illustrated in FIG. 1B. For example, the BMS 130 may include a plurality of sensors, such as temperature sensors 134, voltage/current sensors 136, and other sensors configured to monitor the state and environment of the battery cells 133. Sensor readings may be processed by a BMS controller 138 that includes a processor 140, a memory 142, and other computer system components described in detail below in relation to FIG. 10.

To complete the control loop, the BMS 130 may include one or more devices that are configured to add or remove heat from the plurality of battery cells 133. For example, the BMS may include a TMS that includes a heat exchanger and heat transfer device(s) (e.g., a cold plate, coolant circulation tubes, radiant heating, ventilation, etc.) that can be used to regulate the temperature of the individual battery cells 133 during charging/discharging in the electric vehicle. The BMS 130 can use the control loop to perform a number of different thermal operations in relation to the plurality of battery cells 133. First, the BMS 130 can perform a cooling function that removes heat from the plurality of battery cells 133. For example, when the battery cells 133 reach their optimal temperature performance range, the BMS 130 can circulate liquid coolant through a heat transfer device to remove heat from the batteries 133. Second, the BMS 130 can provide heat to the batteries 133 during cold temperatures. For example, when charging or fast-charging batteries with temperatures below the optimal temperature range, the BMS 130 can heat the batteries 133 by circulating heated material (e.g., fluid, air, etc.) around the batteries 133. Some embodiments may also use electric heating to increase the temperature of the batteries 133. Some embodiments of the BMS 130 can also provide insulation around the batteries 133 to protect against extreme weather outside of the electric vehicle. The BMS 130 may also provide ventilation or air circulation in addition to the basic cooling/heating functions.

Another aspect of the control loop for the BMS 130 may include the monitoring and regulation of electrical characteristics of the battery cells 133. For example, the BMS controller 138 can use the voltage/current sensors 136 to monitor the output current and voltage of subsets of the individual battery cells 133. Prior to this disclosure, this monitoring was limited to the electrical characteristics that could be determined from the individual anodes/cathodes of the battery cells 133 alone. No three-electrode cells had been developed that could be reliably used in-situ during operation of the electric vehicle. However, the embodiments described herein provide the third electrode that can be additionally coupled to the voltage/current sensors 136 to characterize internal kinetics, current densities, reactions, and other electrochemical phenomena that were previously unmeasurable by the BMS 130. These new measurements can be processed by the BMS controller 138 and used to better control the voltage/current output of the battery 120, to better control efficient charging cycles, to better predict battery life cycles, and to increase the lifetime of the battery cells 133.

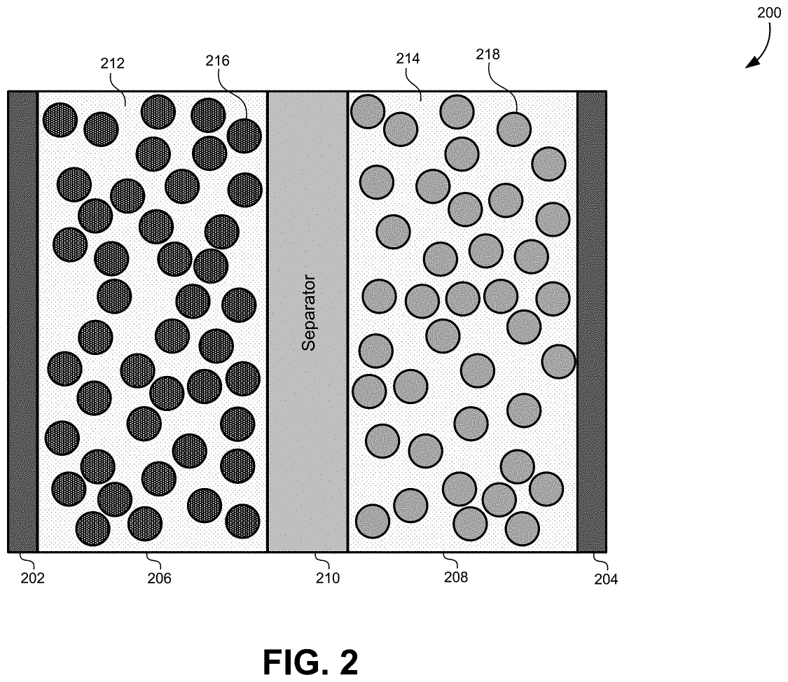

FIG. 2 illustrates a simplified diagram of the layers of a lithium battery 200 that may be used in electric vehicles, according to some embodiments. A typical battery includes thin layers of material that are compressed together and rolled into a cylinder, “jelly roll,” or “Swiss roll.” The jelly roll design is commonly used in a majority of cylindrical rechargeable batteries. In this design, an insulating sheet may be provided, followed by a thin layer of anode material. Next, a separator layer may be applied, and a cathode material may be layered on top. These layers may then be rolled up and inserted into a hollow cylinder casing. As described below, the battery cell may then be sealed, and metal contacts for the anode and/or cathode at the top and bottom of the jelly roll can be coupled to the case and/or cap of the battery. Specifically, the jelly roll may include anode and cathode leads that are connected to terminals of a battery housing that encases and protects the jelly roll. In some embodiments, the anode and cathode can both be coupled to a top cap of the battery cell. FIG. 2 illustrates each of these layers in detail. These layers not only represent the physical layers in an actual lithium battery, they also represent a basic physics model using porous electrode and concentrated solution theories that accurately captures lithium ion migration inside the battery.

A lithium battery may include a pair of current collectors 202, 204 that are connected to the anode and cathode leads respectively. The anode current collector 202 may comprise a sheet of copper, and the cathode current collector 204 may comprise a sheet of aluminum, although other materials may be used for either current collector 202, 204. The battery 200 may include a negative anode electrode 206 and a positive cathode electrode 208 that are isolated by a separator 210. Each electrode 206, 208 may include active particles 216, 218 and electrolyte solutions 212, 214. According to this physics model, the electrolyte phase may be continuous across the anode 206, separator 210, and cathode 208, with a solid particles phase that exists in the anode 206 and cathode 208. The solid active materials 216, 218 can be modeled as a matrix of mono-sized spherical particles as illustrated in FIG. 2.

During the discharge process, lithium may be diffused to the surface of the anode 206 and may undergo an electrochemical reaction. This reaction results in the release of electrons and transfers lithium to the electrolyte phase. The lithium ions may diffuse and conduct through the electrolyte 212, 214 from the anode 206 to the cathode 208 where a similar reaction transfers lithium to the positive solid phase. Lithium is then stored inside the active materials 218 of the cathode 208 as the battery 200 is discharged. Charging the battery 200 can be modeled using the opposite process described above. This lithium-ion transport process in the porous electrode and electrolyte solution can be described by charge and mass conservation laws. For example, charge conservation governs phase potentials, while mass conservation governs the phase concentrations of the electrolyte and solid phases in the chemistry of the battery 200.

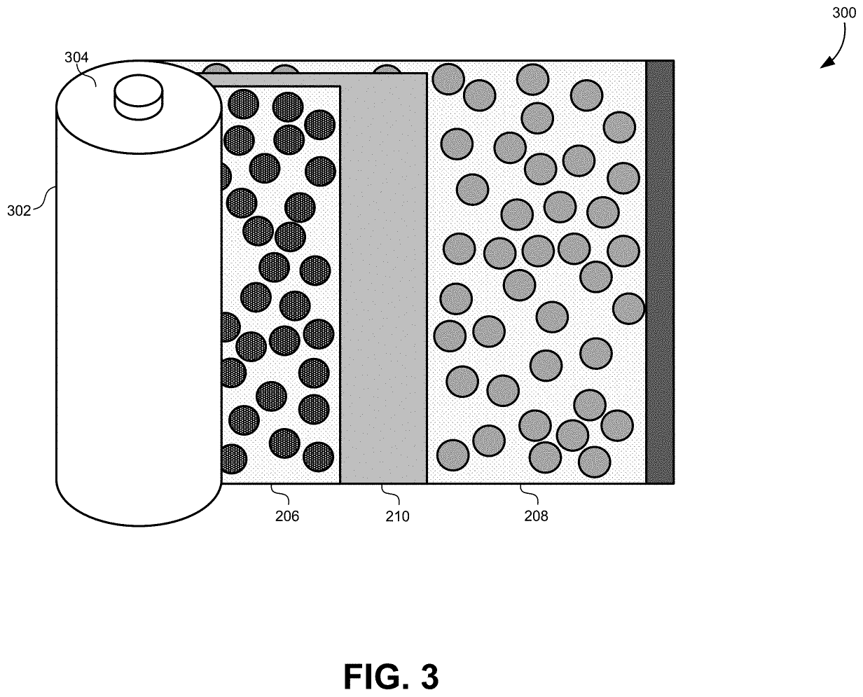

FIG. 3 illustrates a simplified diagram of how the various chemistry layers may be rolled up inside of a battery 300 in a jelly roll configuration, according to some embodiments. Each of the layers described in the model above can be placed in thin sheets on top of each other and rolled up into a cylinder inside of the housing of the battery 200. For example, the anode 206 may include a thin layer of graphite. The cathode 206 may use a layer of the lithium oxide family (e.g., lithium cobalt oxide, lithium manganese oxide, etc.). Each of these layers may be approximately uniform vertically within the battery 200. Therefore, under ideal conditions, current may flow back and forth between the anode 206 and the cathode 208 uniformly at the bottom of the battery 200 and the top of the battery 200, resulting in a nearly uniform current density throughout.

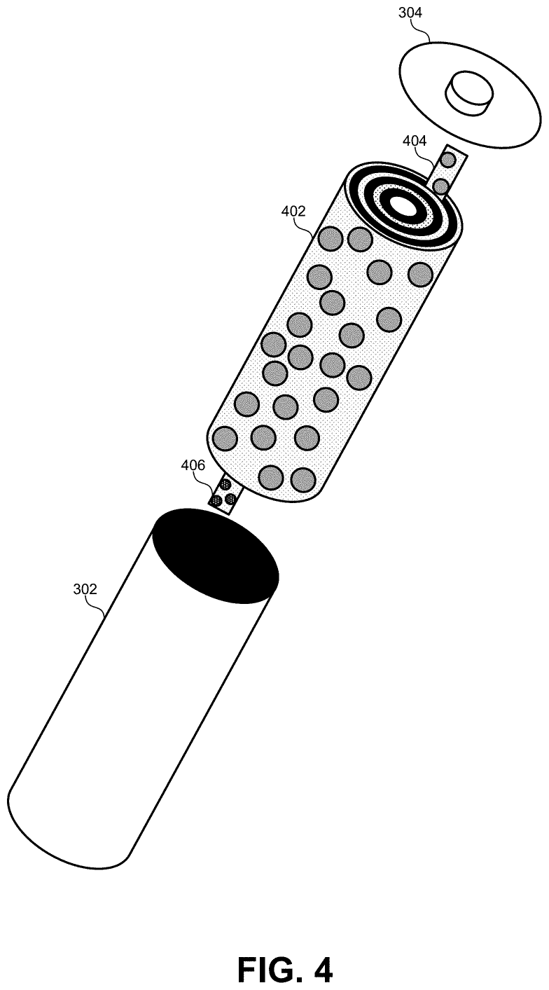

FIG. 4 illustrates a diagram of a traditional battery cell. The traditional battery cell includes a jelly roll 402, a case or “can” 302, and a cap 304. The jelly roll 402 can be rolled up into a cylinder and inserted into the can 302. Afterwards, the cap 304 can be attached to the top of the can 302. The cap 304 can be electrically isolated by an insulator from the can 302. In some embodiments, the can 302 may include an insulator wrapper or case around the exterior of the can such that only the bottom of the can 302 is exposed. The jelly roll 402 may include an electrical lead for the anode 406 and an electrical lead for the cathode 404. The electrical lead for the anode 406 can be coupled to the can 302 such that the can 302 acts as the anode electrode. Similarly, the electrical lead for the cathode 404 can be electrically coupled to the cap 304 such that the entirety of the cap 304 acts as the cathode electrode.

The physical arrangement and assembly process illustrated in FIG. 4 is made possible because in each jelly roll configuration prior to this disclosure, the electrical lead for the anode 406 and the electrical lead for the cathode 404 were located on opposite ends of the cylinder of the jelly roll 402. To generate a third electrical lead in this configuration, holes had to be punched in the layers of the anode and cathode, lined up precisely, and a lithium strip had to be inserted through the anode and cathode layers. The third electrode then had to be threaded between the cap 304 and the can 302 in the final assembly process. This resulted in an invasive procedure that fundamentally altered the electrical characteristics of the battery cell and generally made the battery cell unsuitable for practical applications.

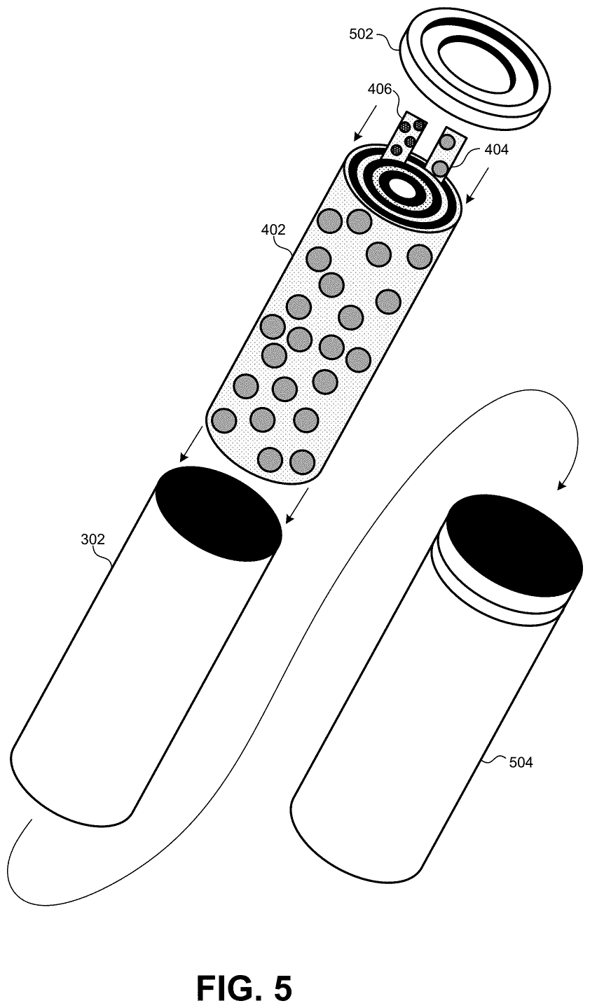

FIG. 5 illustrates a diagram of an embodiment of a battery cell comprising a non-invasive, integrated third electrode, according to some embodiments. There are a number of inventive features that provide for a third lithium electrode in the embodiment depicted in FIG. 5. First, the jelly roll 402 includes the electrical lead for the anode 406 and the electrical lead for the cathode 404 extending out of the same side of the cylinder of the jelly roll 402. In this embodiment, both electrical leads extend from the top of the jelly roll 402. This may be contrasted with previous designs where these electrodes 404, 406 extended from opposite ends of the jelly roll 402.

Next, a new cap 502 has been designed that includes both the anode and cathode electrodes. As will be described in greater detail below, the electrical lead for the anode 406 and the electrical lead for the cathode 404 can both be electrically coupled to the cap 502. The cap 502 can include both electrodes, both of which are electrically isolated from each other and from the can 302.

As described above, the jelly roll 402 can be inserted into the can 302. However, in this embodiment, the jelly roll 402 and the can 302 can then be inserted into a lithium sleeve 504. In some embodiments, the lithium sleeve 504 can be manufactured from a sheet of lithium that is “deep drawn” into the shape of the can 504 depicted in FIG. 5. Deep drawing is a sheet metal forming process in which a sheet of lithium blank can be radially drawn into a forming die by the mechanical action of a punch. This process may be referred to as “deep” when the depth of the drawn part exceeds its diameter, which is the case with the lithium sleeve 504. The lithium sleeve 504 can then be spot welded to the can 302. Spot welding is a process in which the contacting metal surface points between the can 302 and the lithium sleeve 504 are joined by heat obtained from resistance to electrical current. These two pieces can be held together under pressure exerted by the welding electrodes when the current is applied. The lithium sleeve 504 can then be used as the third electrode in the battery cell, providing a lithium reference voltage to which the voltage at the anode and cathode can be compared.

To assemble the three-electrode battery cell of FIG. 5, the jelly roll 402 can be manufactured with both electrodes facing the same direction. The jelly roll 402 can then be inserted into the can 302 that is pre-equipped with a spot welded lithium sleeve 504. The electrical leads, or “tabs”, of the jelly roll 402 can then be welded to the two terminals on the cap 502 as described below. Next, the battery cell can be filled with electrolyte, and the cap 502 can be crimped in place around the lithium sleeve 504. Once assembled, the cell may now have three distinct terminals: the anode and cathode on the cap 502, and the lithium reference on the sleeve 504. An outside observer can now easily measure the voltage between the anode and cathode, the anode and the reference, and/or the cathode and the reference as needed.

The battery cell of FIG. 5 represents the first fully functional commercial cell with a third reference electrode. The advantages of this battery cell are numerous. For example, the cell can provide in-situ characterization of kinetics inside the battery cell during actual use. The measurements received from the reference electrode can be used as inputs for the battery management system and other control algorithms that draw current/voltage from the battery cell. This manufacturing process also represents a nondestructive method for testing, manufacturing, and using battery cells in comparison to previous methods. Additionally, the measurements received through the reference electrode can be used to characterize the full internal cell behavior.

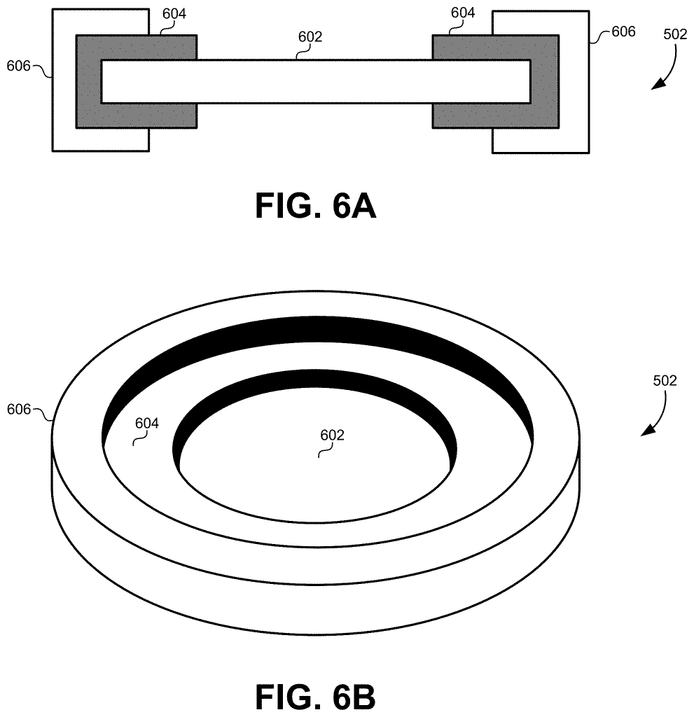

FIGS. 6A-6B illustrate the use of the double-electrode cap 502, according to some embodiments. Generally, the cap 502 can be characterized as having a first metal region and a second metal region that can function as the cathode and anode electrodes. The first metal region can be separated from the second metal region by an insulator such that they are electrically isolated. The first metal region and the second metal region can both be exposed on the top and bottom of the cap 502 such that they can be measured from the top of the cap 502 and coupled to the electrical leads from the jelly roll on the bottom of the cap 502. In a specific example illustrated in FIGS. 6A-6B, the first metal region may include an aluminum disk 602. The aluminum disk 602 may include an insulator 604 that is crimped around the outer circumference of the aluminum disk 602. The second metal region can include another aluminum piece that is crimped around the insulator 604. When attaching the cap 502 to the rest of the battery assembly, a polymer seal can be placed around the exterior of the cap 502, and the cap 502 can then be crimped onto the rest of the battery cell.

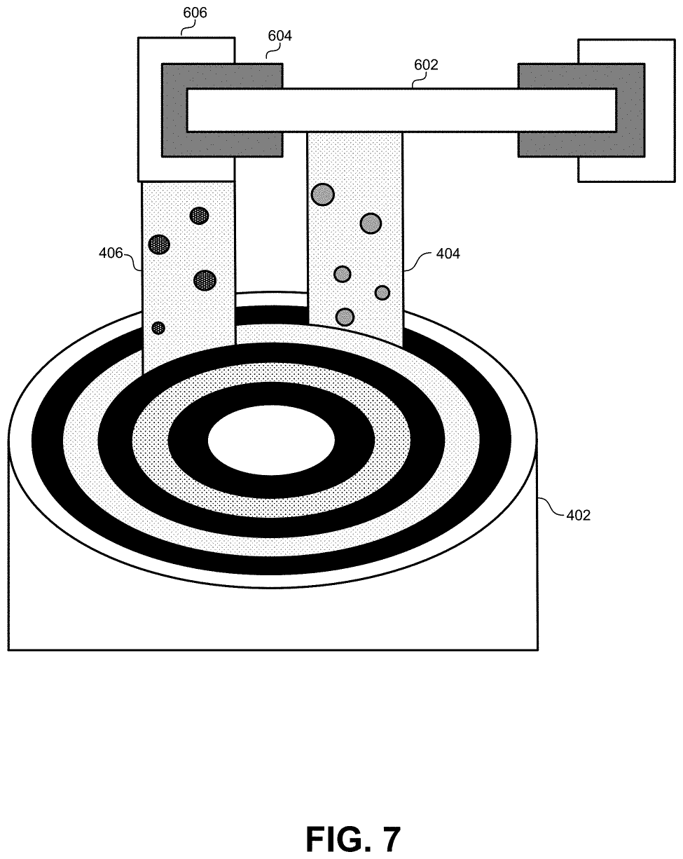

FIG. 7 illustrates a diagram of how the jelly roll 402 can be electrically coupled to the cap 502, according to some embodiments. The tabs or electrical leads 404, 406 from the jelly roll 402 can be coupled to the first and second metal regions on the cap 502. This can be contrasted with existing battery cells where the electrical lead for the anode 406 extended from the bottom of the jelly roll 402 and was electrically coupled to the can of the battery cell. Here, both of the electrical leads 404, 406 can be coupled to the metal regions of the cap 502 such that both the anode and cathode are available at the top of the battery cell. Note that the diagram in FIG. 7 is not drawn to scale. Instead, the electrical leads, active particles, and layers of the jelly roll have been enlarged for clarity.

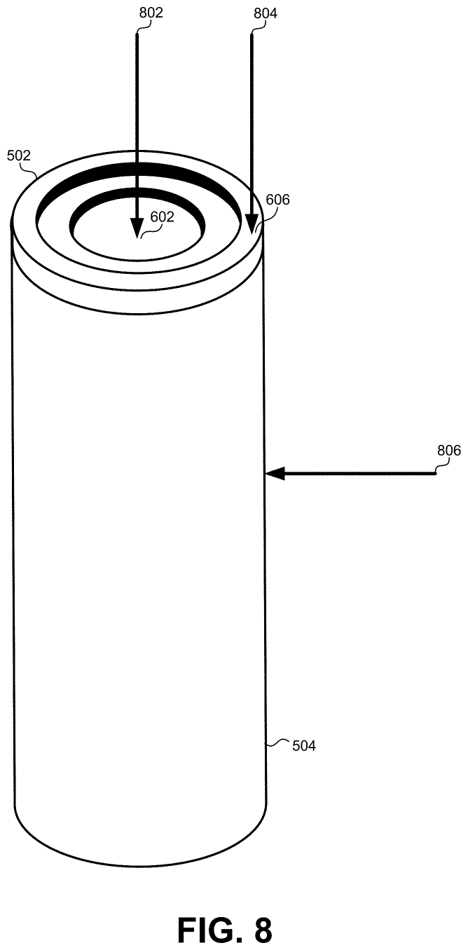

FIG. 8 illustrates an assembled three-electrode battery cell, according to some embodiments. In this diagram, the cap 502 has been crimped or otherwise coupled to the lithium sleeve 504. This diagram also illustrates how measurements can be made at various locations on the three-electrode cell. For example, to measure between the cathode and the lithium reference, measurement leads can be placed at location 802 and location 806. To measure between the anode and the lithium reference, measurement leads can be placed at location 804 and location 806. To measure between the anode and the cathode, measurement leads can be placed at location 802 and location 804. In some embodiments, a plurality of these different measurement configurations can be monitored simultaneously. For example, the BMS described in FIG. 1B can receive measurements between the anode/cathode, anode/reference, and cathode/reference simultaneously to measure the overall output of the battery cell as well as any internal kinetics that may be of interest to control algorithms operated by the BMS.

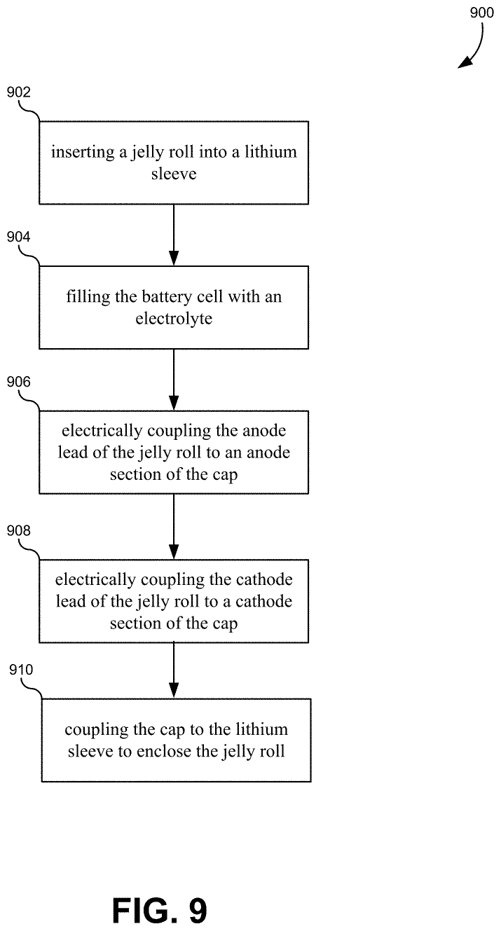

FIG. 9 illustrates a flowchart of a method for assembling a battery cell that provides a non-invasive reference lead, according to some embodiments. The method may include inserting a jelly roll into a lithium sleeve (902). The jelly roll may include an anode lead and a cathode lead extending from the top of the jelly roll. The lithium sleeve may be a deep drawn sleeve that provides a lithium reference lead for the battery cell. In some embodiments, an aluminum battery can may be inserted into the lithium sleeve, and the jelly roll may be inserted into the aluminum can. The aluminum can maybe spot welded to the lithium sleeve. The jelly roll may include anode, cathode, and separator layers for a lithium-ion battery. The lithium sleeve may be cylindrical to fit a cylinder shape of the jelly roll.

The method may also include filling the battery cell with an electrolyte (904). The electrolyte may be a conductive fluid that is poured into the lithium sleeve and/or aluminum can after the jelly roll is inserted. The method may additionally include electrically coupling the anode lead of the jelly roll to an anode section of a cap (906). The method may further include electrically coupling the cathode lead of the jelly roll to a cathode section of the cap (908). The cap may include two metal sections that are electrically isolated by insulator. These two metal sections may form the anode section and the cathode section, or anode electrode and cathode electrode of the battery cell. The anode/cathode leads can be welded to these two sections of the cap.

The method may additionally include coupling the cap to the lithium sleeve to enclose the jelly roll (910). In some embodiments, the cap may be placed on top of the lithium sleeve and crimped to the lithium sleeve to fully encase the jelly roll. The assembled cell may be part of a battery pack in an electric vehicle. In some embodiments, the assembled cell may provide electrical characteristics of the battery to a BMS during operation of the electric vehicle and/or during testing in a laboratory environment. Measurements using the reference lead of the lithium sleeve may characterize internal kinetics of the battery cell that would not otherwise be measurable via the anode/cathode alone.

It should be appreciated that the specific steps illustrated in FIG. 9 provide particular methods of assembling a three-electrode battery cell according to various embodiments. Other sequences of steps may also be performed according to alternative embodiments. For example, alternative embodiments of the present invention may perform the steps outlined above in a different order. Moreover, the individual steps illustrated in FIG. 9 may include multiple sub-steps that may be performed in various sequences as appropriate to the individual step. Furthermore, additional steps may be added or removed depending on the particular applications. One of ordinary skill in the art would recognize many variations, modifications, and alternatives.

The BMS system described above that measures and uses the readings from the lithium reference lead may be implemented by a computer system that comprises an internal system in an electric vehicle, a remote server, a dedicated simulation system, and/or a distributed combination of these various configurations. FIG. 10 illustrates a computer system 1000 that has been specifically designed to implement the BMS or testing systems described herein. Specifically, these hardware and software modules depicted in FIG. 10 may be part of the BMS, part of a simulation system, and/or part of a remote server. As shown in the figure, computer system 1000 includes a processing unit 1004 that communicates with a number of peripheral subsystems via a bus subsystem 1002. These peripheral subsystems may include a processing acceleration unit 1006, an I/O subsystem 1008, a storage subsystem 1018 and a communications subsystem 1024. Storage subsystem 1018 includes tangible computer-readable storage media 1022 and a system memory 1010.

Bus subsystem 1002 provides a mechanism for letting the various components and subsystems of computer system 1000 communicate with each other as intended. Although bus subsystem 1002 is shown schematically as a single bus, alternative embodiments of the bus subsystem may utilize multiple buses. Bus subsystem 1002 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1004, which can be implemented as one or more integrated circuits (e.g., a conventional microprocessor or microcontroller), controls the operation of computer system 1000. One or more processors may be included in processing unit 1004. These processors may include single core or multicore processors. In certain embodiments, processing unit 1004 may be implemented as one or more independent processing units 1032 and/or 1034 with single or multicore processors included in each processing unit. In other embodiments, processing unit 1004 may also be implemented as a quad-core processing unit formed by integrating two dual-core processors into a single chip.

In various embodiments, processing unit 1004 can execute a variety of programs in response to program code and can maintain multiple concurrently executing programs or processes. At any given time, some or all of the program code to be executed can be resident in processor(s) 1004 and/or in storage subsystem 1018. Through suitable programming, processor(s) 1004 can provide various functionalities described above. Computer system 1000 may additionally include a processing acceleration unit 1006, which can include a digital signal processor (DSP), a special-purpose processor, and/or the like.

I/O subsystem 1008 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1000 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1000 may comprise a storage subsystem 1018 that comprises software elements, shown as being currently located within a system memory 1010. System memory 1010 may store program instructions that are loadable and executable on processing unit 1004, as well as data generated during the execution of these programs.

Depending on the configuration and type of computer system 1000, system memory 1010 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 1004. In some implementations, system memory 1010 may include multiple different types of memory, such as static random access memory (SRAM) or dynamic random access memory (DRAM). In some implementations, a basic input/output system (BIOS), containing the basic routines that help to transfer information between elements within computer system 1000, such as during start-up, may typically be stored in the ROM. By way of example, and not limitation, system memory 1010 also illustrates application programs 1012, which may include client applications, Web browsers, mid-tier applications, relational database management systems (RDBMS), etc., program data 1014, and an operating system 1016. By way of example, operating system 1016 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Storage subsystem 1018 may also provide a tangible computer-readable storage medium for storing the basic programming and data constructs that provide the functionality of some embodiments. Software (programs, code modules, instructions) that when executed by a processor provide the functionality described above may be stored in storage subsystem 1018. These software modules or instructions may be executed by processing unit 1004. Storage subsystem 1018 may also provide a repository for storing data used in accordance with the present invention.

Storage subsystem 1000 may also include a computer-readable storage media reader 1020 that can further be connected to computer-readable storage media 1022. Together and, optionally, in combination with system memory 1010, computer-readable storage media 1022 may comprehensively represent remote, local, fixed, and/or removable storage devices plus storage media for temporarily and/or more permanently containing, storing, transmitting, and retrieving computer-readable information.

Computer-readable storage media 1022 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 1000.

By way of example, computer-readable storage media 1022 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1022 may include, but is not limited to, Zip® drives, flash memory cards, universal serial bus (USB) flash drives, secure digital (SD) cards, DVD disks, digital video tape, and the like. Computer-readable storage media 1022 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1000.

Communications subsystem 1024 provides an interface to other computer systems and networks. Communications subsystem 1024 serves as an interface for receiving data from and transmitting data to other systems from computer system 1000. For example, communications subsystem 1024 may enable computer system 1000 to connect to one or more devices via the Internet. In some embodiments communications subsystem 1024 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1024 can provide wired network connectivity (e.g., Ethernet) in addition to or instead of a wireless interface.

In some embodiments, communications subsystem 1024 may also receive input communication in the form of structured and/or unstructured data feeds 1026, event streams 1028, event updates 1030, and the like on behalf of one or more users who may use computer system 1000.

By way of example, communications subsystem 1024 may be configured to receive data feeds 1026 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1024 may also be configured to receive data in the form of continuous data streams, which may include event streams 1028 of real-time events and/or event updates 1030, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 1024 may also be configured to output the structured and/or unstructured data feeds 1026, event streams 1028, event updates 1030, and the like to one or more databases that may be in communication with one or more streaming data source computers coupled to computer system 1000.

Computer system 1000 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1000 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

In the foregoing description, for the purposes of explanation, numerous specific details were set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The foregoing description provides exemplary embodiments only, and is not intended to limit the scope, applicability, or configuration of the disclosure. Rather, the foregoing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the foregoing description to provide a thorough understanding of the embodiments. However, it will be understood by one of ordinary skill in the art that the embodiments may be practiced without these specific details. For example, circuits, systems, networks, processes, and other components may have been shown as components in block diagram form in order not to obscure the embodiments in unnecessary detail. In other instances, well-known circuits, processes, algorithms, structures, and techniques may have been shown without unnecessary detail in order to avoid obscuring the embodiments.

Also, it is noted that individual embodiments may have beeen described as a process which is depicted as a flowchart, a flow diagram, a data flow diagram, a structure diagram, or a block diagram. Although a flowchart may have described the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to portable or fixed storage devices, optical storage devices, wireless channels and various other mediums capable of storing, containing, or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

In the foregoing specification, aspects of the invention are described with reference to specific embodiments thereof, but those skilled in the art will recognize that the invention is not limited thereto. Various features and aspects of the above-described invention may be used individually or jointly. Further, embodiments can be utilized in any number of environments and applications beyond those described herein without departing from the broader spirit and scope of the specification. The specification and drawings are, accordingly, to be regarded as illustrative rather than restrictive.

Additionally, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

What is claimed is:

1. A battery cell providing a non-invasive reference lead, the battery cell comprising:
a cap positioned at a top of the battery cell, wherein the cap comprises an anode section and a cathode section separated by an insulator section;
a jelly roll comprising an anode lead and a cathode lead extending from a top of the jelly roll, wherein:
the anode lead of the jelly roll is electrically coupled to the anode section of the cap; and
the cathode lead of the jelly roll is electrically coupled to the cathode section of the cap; and
a lithium sleeve providing a reference lead for the battery cell, wherein the lithium sleeve and the cap enclose the jelly roll.

2. The battery cell of claim 1, further comprising an aluminum can between the jelly roll and the lithium sleeve.

3. The battery cell of claim 2, wherein the aluminum can is spot welded to the lithium sleeve.

4. The battery cell of claim 1, wherein the jellyroll forms a lithium-ion battery cell.

5. The battery cell of claim 1, wherein the lithium sleeve comprises a cylindrical shape with a closed bottom and an open top.

6. The battery cell of claim 1, wherein the battery cell is one of a plurality of battery cells providing power to an electric vehicle.

7. The battery cell of claim 1, wherein the cap comprises a first aluminum section surrounded by an insulator.

8. The battery cell of claim 7, wherein the cap further comprises a second aluminum section that is crimped around the insulator.

9. The battery cell of claim 1, wherein an electrical measurement between the anode and the cathode can be obtained from the cap without accessing the lithium sleeve.

10. The battery cell of claim 1, wherein the battery cell is part of a laboratory test environment.

11. A method of providing a battery cell with a non-invasive reference lead, the method comprising:
inserting a jelly roll into a lithium sleeve, wherein:
the jelly roll comprises an anode lead and a cathode lead extending from a top of the jelly roll; and
the lithium sleeve provides a reference lead for the battery cell;
filling the battery cell with electrolyte;
coupling a cap to the lithium sleeve to enclose the jelly roll, wherein the cap comprises an anode section and a cathode section separated by an insulator section;
electrically coupling the anode lead of the jelly roll to the anode section of the cap; and
electrically coupling the cathode lead of the jelly roll to the cathode section of the cap.

12. The method of claim 11, further comprising obtaining an electrical measurement between the anode section and the cathode section of the cap.

13. The method of claim 11, further comprising obtaining an electrical measurement between the anode section of the cap and the reference lead.

14. The method of claim 11, further comprising obtaining an electrical measurement between the cathode section of the cap and the reference lead.

15. The method of claim 11, further comprising providing an electrical measurement using the reference lead to a Battery Management System (BMS) of an electric vehicle.

16. The method of claim 11, further comprising inserting the jellyroll into an aluminum can, and inserting the aluminum can into the lithium sleeve.

17. The method of claim 16, further comprising spot welding a bottom of the aluminum can to a bottom of the lithium sleeve.

18. The method of claim 11, wherein the jellyroll comprises layers of a lithium-ion battery cell.

19. The method of claim 11, further comprising providing power from the battery cell to electric motor of an electric vehicle.

20. The method of claim 11, wherein the cap comprises a first aluminum section surrounded by an insulator.
